(19) United States
(12) Patent Application Publication
(10) Pub. No.: US 2014/0138008 A1
(43) Pub. Date: May 22, 2014

(54) METHOD FOR PRODUCING A TAPE FOR AN ELECTRICAL INSULATION SYSTEM

(71) Applicants: Peter Gröppel, Erlangen (DE); Thomas Hildinger, Santana de Parnaiba (BR); Igor Ritberg, Furth (DE)

(72) Inventors: Peter Gröppel, Erlangen (DE); Thomas Hildinger, Santana de Parnaiba (BR); Igor Ritberg, Furth (DE)

(73) Assignees: VOITH PATENT GMBH, Heidenheim (DE); SIEMENS AKTIENGESELLSCHAFT, München (DE)

(21) Appl. No.: 14/232,840

(22) PCT Filed: Jul. 18, 2012
(86) PCT No.: PCT/EP2012/064046

§ 371 Date: Jan. 31, 2014

(30) Foreign Application Priority Data
Jul. 20, 2011 (DE) 10 2011 079 489.1

(51) Int. Cl. H01B 3/52

(52) U.S. Cl. CPC H01B 3/52
USPC 156/53

(57) ABSTRACT

A method for producing tape for an electrical insulation system, including the following steps: providing a porous insulation paper; providing a resin that has nano-scale particles suspended therein; saturating the insulation paper with the resin such that the resin and particles become dispersed in the insulation paper; and finishing the tape.

The invention relates to a process for producing a tape for an electric insulation system.

Electric machines, e.g. motors and generators, have electric conductors, an electric insulation system and a stator plate packet. The insulation system has the purpose of electrically insulating the conductors from one another, from the stator plate packet and from the surroundings. In the case of mechanical or thermal stress in operation of the machine, hollow spaces can be formed at the interfaces between the insulation system and the conductor or between the insulation system and the stator plate packet, in which hollow spaces sparks can be formed by partial electric discharges. These sparks can form “treeing” channels in the insulation. The “treeing” channels can result in electrical puncture through the insulation. A barrier against the partial discharges is produced by the use of mica, which has a high partial discharge stability, in the insulation. The mica is used in the form of platelet-like mica particles having a normal particle size of from several 100 microns to several millimeters, with the mica particles being processed to form a mica paper. To increase the strength and to improve the processability, a tape is used in which the mica paper is adhesively bonded by means of an adhesive to a support structure.

The use of inorganic nanoparticles in insulation systems in order to improve the partial discharge stability of the insulation system is known. The partial discharge stability of the insulation system increases with increasing surface area of the particles and thus depends on their diameter and their shape. In addition, the partial discharge stability increases with increasing proportion by mass of the nanoparticles based on the insulation system. The nanoparticles can be coated.

Compared to mica, resin has a low partial discharge stability, as a result of which insulation systems produced by both processes are susceptible to the formation of “treeing” channels. This reduces the life of the insulation systems.

DE 601 09 422 T2 describes a process for producing an insulation system. However, this suffers from the problem that the maximum achievable proportion by mass of nanosize particles is low.

It is an object of the invention to provide a process for producing a tape for an insulation system, where the partial discharge stability of the insulation system is high and the life of the insulation system is long.

The process of the invention for producing a tape for an electric insulation system has the following steps: provision of a porous insulation paper; provision of a resin in which nanosize particles are suspended; complete impregnation of the insulation paper with the resin, as a result of which the resin and the particles are distributed in the insulation paper; manufacture of the tape.

The tape produced in this way can advantageously be processed further in a process under superatmospheric pressure, as a result of which a high proportion by mass of the resin based on the insulation system can be achieved. Owing to the high proportion by mass of the resin, a high proportion by mass of the nanoparticles based on the insulation system is also advantageously achievable, as a result of which the life of the insulation system is improved.

The tape preferably has a support structure. In this way, a higher strength and a better processability of the tape are advantageously achieved. The insulation paper is preferably a mica paper. Furthermore, the resin is preferably an aromatic epoxy resin, in particular BADGE, BFDGE, epoxidized phenol novolaks or epoxidized kresol novolaks, with an anhydride or an amine as hardener. After complete impregnation of the insulation paper with the resin, the latter is preferably partially crosslinked by supply of heat in such a way that the resin is in a tack-free state and can be fully cured subsequently. Furthermore, the tape preferably has a thickness of from 100 μm to 300 μm.

The particles preferably comprise inorganic material, in particular titanium dioxide, silicon dioxide and/or aluminum oxide. The inorganic particles advantageously have a high partial discharge stability. Furthermore, the particles preferably have a particle diameter of from 1 nm to 50 nm. The particles preferably have a specific surface area which is greater than 25 m²/g. The high specific surface area advantageously results in a high partial discharge stability of the insulation system.

To impregnate the insulation paper completely with the resin, a solvent, in particular 2-butanone, ethanol, butyl acetate or ethyl acetate, is preferably added to the resin so as to reduce the viscosity of the resin. Furthermore, a quantity of heat is preferably supplied to the resin for the complete impregnation of the insulation paper with the resin in order to reduce the viscosity of the resin. That is to say, in order to reduce the viscosity of the resin further, preference is given to supplying the quantity of heat to the resin for complete impregnation of the insulation paper with the resin. After the insulation paper has been completely impregnated, the solvent is preferably removed from the insulation paper. Here, the quantity of heat is preferably determined in such a way that, during removal of the solvent, the resin is partially crosslinked in such a way that the resin is present in a tack-free state and can subsequently be fully cured. As a result of the two measures, namely the addition of solvents or supply of a quantity of heat in order to reduce the viscosity, a high concentration of the particles in the resin can advantageously be achieved, so that the insulation system comprising the tape produced according to the invention has a high proportion by mass of the particles based on the insulation system, as a result of which the insulation system has a high partial discharge stability. The proportion by mass of the particles based on the insulation system is, according to the invention, more than 3%, in particular in the range from 3% to 10%.

The tape according to the invention for an electric insulation system is produced by the process of the invention. The tape according to the invention envelops an electric conductor and the insulation system is produced by pressing of the tape and by curing of the resin by supply of heat.

The process of the invention will be illustrated below with the aid of examples.

A porous mica paper which is provided with a support structure is completely impregnated by a resin which comprises an epoxidized phenol novolak and an anhydride as hardener and in which titanium dioxide particles having a particle diameter of 20 nm are suspended. To effect complete impregnation, the solvent ethyl acetate is added to the resin so that the viscosity of the resin is reduced. To reduce the viscosity further, the resin is heated, as a result of which the resin is also partially crosslinked in such a way that it is present in a tack-free state and can subsequently be fully cured. Furthermore, the solvent is removed from the mica paper after the mica paper has been completely impregnated. The tape produced by this process is wound around a conductor. Hollow spaces in the winding and between the conductor and the winding are filled by pressing of the tape in a press, with excess resin running out of the winding. Supply of heat cures the resin and produces the insulation system. The concentration of the titanium dioxide particles in the resin was selected so that the proportion by mass of the titanium dioxide particles based on the insulation system is 4%.

A porous mica paper which is provided with a support structure is completely impregnated by a resin which comprises BADGE and an anhydride as hardener and in which silicon dioxide particles having a particle diameter of 10 nm are suspended. To effect complete impregnation, the solvent ethanol is added to the resin so that the viscosity of the resin is reduced. After complete impregnation, the solvent is removed from the mica paper by vacuum drying. After complete impregnation and removal of the solvent, the resin is partially crosslinked by supply of heat in such a way that the resin is present in a tack-free state and can subsequently be fully cured. The tape produced by this process is wound around a conductor. Hollow spaces in the winding and between the conductor and the winding are filled by pressing of the tape in a press, with excess resin running out of the winding. Supply of heat cures the resin and produces the insulation system. The concentration of the silicon dioxide particles in the resin was selected so that the proportion by mass of the silicon dioxide particles based on the insulation system is 6%.

A porous mica paper which is provided with a support structure is completely impregnated by a resin which comprises BADGE and an anhydride as hardener and in which silicon dioxide particles having a particle diameter of 10 nm are suspended. To effect complete impregnation, the solvent ethanol is added to the resin so that the viscosity of the resin is reduced. The tape is dried by supply of heat. Further heat is supplied so as to partially crosslink the resin in such a way that the resin is present in a tack-free state and can subsequently be fully cured. The tape produced by this process is wound around a conductor. Hollow spaces in the winding and between the conductor and the winding are filled by pressing of the tape in a press, with excess resin and solvent running out of the winding. Supply of heat cures the resin and produces the insulation system. The concentration of the silicon dioxide particles in the resin was selected so that the proportion by mass of the silicon dioxide particles based on the insulation system is 3%.

1. A process for producing an electric insulation system, which comprises the steps:
providing a porous insulation paper;
providing a resin in which nanosize particles are suspended;
completely impregnating the insulation paper with the resin, such that the resin and the particles are distributed in the insulation paper;
manufacturing a tape from the completely impregnated insulation paper;
winding the tape around a conductor;
pressing the tape and curing the resin by supplying heat to the resin such that, the proportion by mass of the particles based on the insulation system is greater than 3%.

2. The process as claimed in claim 1, wherein the tape has a support structure.

3. The process as claimed in claim 1, wherein the insulation paper is a mica paper.

4. The process as claimed in claim 1, wherein the resin is an aromatic epoxy resin.

5. The process as claimed in claim 1, wherein, after complete impregnation of the insulation paper with the resin, partially crosslinking the resin by supplying heat in such a way that the resin is present in a tack-free state and the resin can subsequently be fully cured.

6. The process as claimed in claim 1, wherein the tape has a thickness of from 100 μm to 300 μm.

7. The process as claimed in claim 1, wherein the particles comprise inorganic material.

8. The process as claimed in claim 1, wherein the particles have a particle diameter of from 1 nm to 50 nm.

9. The process as claimed in claim 1, wherein the particles have a specific surface area which is greater than 25 m²/g.

10. The process as claimed in claim 1, wherein, in order to completely impregnate the insulation paper with the resin, adding a solvent, to the resin for reducing viscosity of the resin.

11. The process as claimed in claim 1, wherein, to completely impregnate the insulation paper with the resin, supplying a quantity of heat to the resin for reducing viscosity of the resin.

12. The process as claimed in claim 11, further comprising removing the solvent from the insulation paper after complete impregnation of the insulation paper.

13. The process as claimed in claim 1, wherein the proportion by mass of the particles based on the insulation system is in the range from 3% to 10%.

14. The process in claim 4, wherein the resin comprises BADGE, BFDGE, epoxidized phenol novolaks or epoxidized kresol novolaks, with an anhydride or an amine as hardener.

15. The process in claim 7, wherein the inorganic material comprises titanium dioxide, silicon dioxide and/or aluminum oxide.

16. The process in claim 10, wherein the solvent comprises 2-butanone, ethanol, butyl acetate or ethyl acetate.
